(19) United States
(12) Patent Application Publication
(10) Pub. No.: US 2024/0253249 A1
(43) Pub. Date: Aug. 1, 2024

(54) OPERATING DEVICE FOR A TUBE LIFTER, AND TUBE LIFTER

(71) Applicant: J.Schmalz GmbH, Glatten (DE)

(72) Inventors: Hans Burt, Horb a.N. (DE); Daniel Müller, Haiterbach (DE); Fabian Urbschat, Baiersbronn (DE); Stefan Dreher, Wildberg (DE); Arthur Hoppe, Loßburg (DE)

(73) Assignee: J.Schmalz GmbH, Glatten (DE)

(21) Appl. No.: 18/429,624

(22) Filed: Feb. 1, 2024

(30) Foreign Application Priority Data
Feb. 1, 2023 (DE) 10 2023 102 438.8

(51) Int. Cl. B25J 15/06; B25J 9/14; B25J 13/02

(52) U.S. Cl. CPC B25J 15/0625; B25J 9/144; B25J 13/02

(57) ABSTRACT

An operating device for a tube lifter which comprises an end effector and a lifting tube, comprising a lifting tube port for fluidic connection to the tube interior of the lifting tube, an end effector coupling for coupling the end effector to the operating device, a valve device for controlling fluidic connections and an operating mechanism for actuating the valve device, wherein the valve device comprises a ventilation valve for ventilating the lifting tube port, wherein the ventilation valve has a valve flap, which is adjustable between an open position and a closed position, wherein the operating mechanism comprises a first operating element and a second operating element, wherein the first and the second operating element are mechanically coupled to the valve flap in such a way that, by actuating the first and/or the second operating element, an opening angle of the valve flap is adjustable.

The invention relates to an operating device for a tube lifter and to a tube lifter which is equipped with an operating device of this kind.

Tube lifters are vacuum handling devices by means of which loads can be lifted, optionally moved and then set down again by means of a vacuum. The lifting force is exerted by means of a lifting tube which can be shortened by applying a vacuum to the tube interior thereof and can be extended again by releasing the vacuum prevailing therein. An end effector for gripping an object is usually arranged at one end of the lifting tube. This can be a mechanical gripping device, but in particular a suction gripping device.

In order to operate the lifting tube and/or the end effector, an operating device is provided between the lifting tube and the end effector, which operating device generally comprises a ventilation valve for ventilating the tube interior and/or the end effector.

DE 10 2008 028 205 C5 discloses a generic operating device for tube lifters comprising a handle which has a manually actuatable trigger. The trigger controls a ventilation valve through which an inflow of ambient air into the lifting tube is controlled. Specifically, when the trigger is actuated, air is supplied to the lifting tube from the surroundings of the lifting tube, as a result of which the pressure in the tube interior is increased and the lifting tube can subsequently extend, possibly under the effect of gravity. If the trigger is released, the ventilation valve closes again, so that an inflow of ambient air into the lifting tube is interrupted, as a result of which the lifting tube automatically contracts again in the direction of its end position.

However, this automatic movement into the end position is not always desired. Instead, it can be advantageous if the tube lifter does not move into the end position but remains at a preset suspended height, for example in order to be able to grasp the operating device for preparing a next transport process of a workpiece from this working height. For this purpose, it is known to provide a separate latching lever on the operating device, which locking lever locks the trigger in a defined switching position and thus allows a defined inflow of ambient air.

The object of the invention is to design an operation of a tube lifter more intuitively. Furthermore, a reliable and at the same time cost-effective design is desirable.

This object is achieved according to the invention by an operating device having the features of claim 1. The operating device is designed to operate a tube lifter. In particular, the operating device is a single-hand operating device for a tube lifter. In this respect, the operating device can be designed such that it can be operated with one hand.

The tube lifter comprises an end effector, in particular in the form of a suction gripping device, and a lifting tube. The lifting tube has a tube interior. The lifting tube can be shortened by applying a vacuum to the tube interior and can be extended again by ventilating the tube interior (i.e. by flowing air, in particular ambient air, into the tube interior).

The operating device comprises a lifting tube port for fluidic connection to the tube interior of the lifting tube. In particular, the operating device also comprises a connection device for attaching the operating device to the lifting tube.

The operating device also comprises an end effector coupling for coupling the end effector to the operating device. In this respect, the end effector is connectable to the lifting tube via the operating device. The end effector coupling is preferably arranged on a side of the operating device opposite the lifting tube port. When used in a tube lifter, the operating device is in particular arranged between the lifting tube and the end effector.

The operating device also comprises a valve device for controlling fluidic connections, in particular a fluidic connection between the lifting tube and the surroundings, and optionally a fluidic connection between the lifting tube and the end effector.

The operating device also comprises an operating mechanism for actuating the valve device.

The valve device comprises a ventilation valve for ventilating the lifting tube port and thus—when the lifting tube is attached—for ventilating the tube interior of the lifting tube. The ventilation valve is designed in particular to connect the lifting tube port to the surroundings of the operating device if necessary. In this respect, ambient air can flow into the lifting tube port via the ventilation valve.

The ventilation valve comprises a valve flap. The valve flap is in particular pivotable about a pivot axis. The valve flap is adjustable between an open position and a closed position, preferably in such a way that the valve flap can assume, between the open position and the closed position (as the two end positions), different, in particular any, intermediate positions or opening angles.

In the open position of the valve flap, a flow path from the lifting tube port to the surroundings of the operating device, in particular to a ventilation port of the operating device, is released. In the closed position, this flow path, i.e., the flow path between the lifting tube port and the surroundings, is closed. In this respect, the valve flap is in particular arranged in a flow path between the lifting tube port and the surroundings or ventilation port.

The operating mechanism comprises a first operating element and a second, in particular a separately operable, operating element. The first operating element and the second operating element are mechanically coupled to the valve flap in such a way that an opening angle of the valve flap is adjustable by mechanically, in particular manually, actuating, in particular pressing, the first and/or the second operating element, i.e., the valve flap is adjustable between the closed position and the open position. In particular, the first operating element and the second operating element are mechanically coupled to the valve flap in such a way that the valve flap can be transferred into the closed position by actuating, in particular pressing, the first operating element, and the valve flap can be transferred into the open position by actuating, in particular pressing, the second operating element.

The proposed operating device enables a particularly intuitive operation of the tube lifter. In particular, by means of the operating mechanism with two operating elements, a structurally simple operating possibility with intuitive handling is created in order to precisely control a change in length of the lifting tube, so that rapid handling processes can also be carried out reliably. In contrast to configurations with valves movable by electric motor, the proposed operating device is additionally particularly cost-effective and easy to realize in terms of the design. Furthermore, it is not necessary to keep an electrical power supply on the operating device, which further reduces complexity.

The first and the second operating element are preferably arranged, in particular held, manually adjustably on the operating device. In particular, the first operating element and the second operating element can be mounted on the operating device in a translationally or rotationally displaceable, preferably linearly guided manner. Such a design enables a simple operation and also direct feedback to an operator, in which valve position the ventilation valve or the valve flap is located. The operating device can advantageously have a housing, in particular in the form of an operating handle. The first operating element and the second operating element can then be mounted displaceably on the housing, in particular on the operating handle.

Advantageously, the first operating element and the second operating element can each be mechanically coupled to the valve flap via a transmission device, in particular in such a way that an adjusting movement of the first operating element and/or an adjusting movement of the second operating element (as a result of a manual actuation of the operating elements) is transmitted into an adjusting movement (opening movement or into a closing movement) of the valve flap.

Within the scope of a particularly advantageous development, the operating mechanism, in particular the first operating element, the second operating element and/or the above-described transmission device, are designed to be self-locking, in particular mechanically braked, in such a way that the valve flap remains in a set configuration, i.e., in particular when the first and the second operating element are released, it is not automatically moved back into an initial configuration. For example, it is conceivable that the first operating element, the second operating element and/or the transmission device are mounted in a dragging fashion.

Alternatively or additionally, the valve flap can also be designed or mounted correspondingly in a self-locking manner. Such an embodiment makes it possible to realize a suspended position of the lifting tube. Because the valve flap remains in its set configuration even when the operating device is released, the lifting tube does not move automatically into the (shortened) end position as usual, but remains in an equilibrium position corresponding to the open position of the valve flap. In this way, the end effector can be “parked” at an ergonomically favorable working height, for example in order to be able to grasp the operating device for preparing a next transport process of a workpiece from this working height. In addition, uncontrolled contraction of the lifting tube can be prevented.

The valve flap is in particular mounted on the operating device so as to be pivotable about a pivot axis. The pivot axis can run in the valve flap plane or can run at a distance from the valve flap plane. Advantageously, the first operating element and the second operating element can be mechanically coupled to the valve flap via a transmission device in such a way that an, in particular translational, adjusting movement of the first operating element and/or an, in particular translational, adjusting movement of the second operating element (as a result of a manual actuation of the operating elements) is transmitted into a pivoting movement of the valve flap about the pivot axis.

The valve flap can advantageously be mounted centrally. In this respect, the valve flap can be held on the operating device so as to be pivotable about a pivot axis arranged centrally in relation to the valve flap. In other words, the valve flap is preferably held on the operating device so as to be pivotable about a pivot axis in such a way that ends of the valve flap opposite one another in relation to the pivot axis move on a common circular path about the pivot axis when the valve flap is pivoted about the pivot axis. Such an embodiment has the advantage that no movement force is exerted on the valve flap even when a vacuum is applied on one side, which reduces the risk of unintentional actuation of the valve flap and thus further improves a suspension control. It can be particularly advantageous if the valve flap is designed in the form of a circular disk. The pivot axis can then run through the circle center of the valve flap.

Within the scope of an advantageous development, the first operating element can be mechanically coupled, in particular connected, to the valve flap via a first connecting element, in particular a first connecting rod. The second operating element can be mechanically coupled, in particular connected, to the valve flap via a second connecting element, in particular a second connecting rod. Preferably, the first and the second connecting elements engage with the valve flap on the same side of the valve flap, but in relation to a pivot axis of the valve flap on opposite portions of the valve flap. In this respect, it can be advantageous if the first connecting element engages with a first portion of the valve flap and the second connecting element engages with a second portion of the valve flap, wherein the first portion and the second portion are arranged opposite one another in relation to a pivot axis of the valve flap. Such an embodiment makes it possible to adjust an opening angle of the valve flap in a structurally simple and reliable manner.

In this context, it is conceivable that the first operating element and the second operating element are each pivotably mounted both on the operating element associated with them and on the valve flap. In this respect, the first connecting element can be pivotably mounted both on the first operating element and on the valve flap, and the second operating element can be pivotably mounted both on the second operating element and on the valve flap.

Particularly intuitive operation can then arise if the first operating element and the second operating element can, in particular alternately, assume an actuating position and a non-actuating position. In particular, the valve flap is open, in particular in the open position, in the actuating position of the first operating element in the closed position and in the actuating position of the second operating element. In the present context, ‘alternately’ means in particular that when the first operating element is in the actuating position, the second operating element is not in the actuating position, preferably in the non-actuating position, and vice versa. Such an embodiment further contributes to a particularly intuitive operation. In addition, maloperation can be avoided, since a simultaneous actuation of the first and the second operating element, i.e., a simultaneous transfer of the first and the second operating element into the actuating position, can be prevented.

In this context, it can be particularly advantageous if the first operating element and the second operating element, in particular via the valve flap, are mechanically forcibly coupled in such a way that, when the first operating element is transferred in the direction of the actuating position (i.e., when the first operating element is actuated), the second operating element is forcibly transferred in the direction of the non-actuating position, and vice versa. In this way, the risk of incorrect operation can be further reduced. Preferably, the first operating element and the second operating element can be mechanically forcibly coupled, in particular via the valve flap, in such a way that, when the first operating element is in the actuating position, the second operating element is in the non-actuating position, and vice versa.

The actuating position and the non-actuating position are preferably each end positions of the operating elements. As mentioned above, the operating elements can be mounted on the operating device, for example so as to be displaceable translationally or rotationally, in particular so as to be guided linearly. The actuating position and the non-actuating position can then define respective end positions of an adjustment range or pivoting range of the operating elements.

In addition, it can be advantageous if the first operating element and the second operating element pass through respective neutral positions between their respective actuating positions and their respective non-actuating positions. In this respect, the operating elements can each assume an actuating position, a non-actuating position and an intermediate neutral position. Preferably, the first operating element and the second operating element are synchronized, in particular forcibly coupled, in such a way that, when the first operating element is in the neutral position, the second operating element is likewise in the neutral position.

The valve flap is preferably at least partially open in the neutral position of the first and of the second operating element. In this respect, the actuating mechanism can be designed such that the valve flap assumes an opening angle between the open position and the closed position when the first and the second operating element are in the neutral position. The opening angle of the valve flap in the neutral position of the operating elements can in particular be selected such that the lifting tube assumes a predefined length (suspended position).

As mentioned above, the operating device can advantageously have a housing on which the first and the second operating element are mounted so as to be displaceable, in particular are guided linearly. It can then be particularly advantageous if the first and the second operating element are mounted so as to be displaceable on the housing, in particular are guided linearly, in such a way that, in their respective actuating positions relative to their neutral position, the operating elements are inserted into the housing at least in portions and in their non-actuating position protrude from the housing relative to their neutral position at least in portions. In this way, a direct haptic feedback to the operating position of the corresponding operating element and thus to a valve position of the valve device can be provided to an operator in a structurally simple manner, which further improves an intuitive operation and reduces maloperation.

It can also be particularly advantageous if the housing comprises an operating handle, in particular one that can be grasped with just one hand, for the manual gripping of the operating device. The first and the second operating elements can then be arranged on the operating handle, in particular in such a way that the first operating element can be actuated with a first finger of a hand, in particular the index finger, and the second operating element can be actuated with a second finger of the hand, in particular the middle finger. For example, the housing can comprise a pistol-grip-like operating handle, the first and the second operating elements being provided in the manner of a pistol trigger on the operating handle.

Within the scope of an advantageous development, the end effector coupling can comprise a suction port for fluidic connection to the end effector, in particular a suction gripping device. It can then be advantageous if the lifting tube port and the suction port are fluidically connected to one another via a fluid guide, in particular in the form of a tube or a suction tube. The operating device can in this respect have a fluidic connection or fluid line between the suction port and the lifting tube port. For example, the fluid guide can be designed in the form of a suction tube line or a tube. Such an embodiment makes it possible to supply the end effector, in particular in the case of an embodiment as a suction gripping device, with a vacuum through the lifting tube.

In this context, it can also be advantageous if the valve device also comprises a shut-off valve for shutting off or releasing a flow path between the lifting tube port and the suction port, in particular by the fluid guide. When used in a tube lifter, the shut-off valve can be designed to fluidically separate the lifting tube and the end effector from one another if necessary. In an embodiment of the end effector as a suction gripping device, it is thus possible to control, for example, via the shut-off valve whether or not a suction body of the suction gripping device is supplied with a vacuum.

The shut-off valve can have a shut-off element, in particular a shut-off flap, which can assume a release position and a blocking position, wherein in the release position the flow path between the lifting tube port and the suction port is released, and in the blocking position this flow path is closed. Preferably, the shut-off member is designed to close the above-mentioned fluid guide between the suction port and the lifting tube port.

The shut-off valve can be actuated via a third operating element. However, it is particularly advantageous if the shut-off valve can be actuated by means of the first and/or the second operating element, which favors simple operation.

It can be particularly advantageous if the shut-off member of the shut-off valve and the valve flap of the ventilation valve are mechanically coupled via the first and/or the second operating element, in particular in such a way that the shut-off member is in the release position when the valve flap of the ventilation valve is in the closed position. When the operating device in a tube lifter with a suction gripping device is used, for example after the suction gripping device has been placed onto an object to be gripped, in particular with only one operating operation, the shut-off member can then be transferred into the release position (suction gripping device is supplied with a vacuum in this respect, and the object is suctioned), and at the same time the ventilation valve can be transferred into the closed position (lifting tube then contracts due to the vacuum that builds up, so that the object is raised).

In the context of a design which is simple in its structure and reliable in operation, the shut-off member can be designed as a shut-off flap. The shut-off flap can in particular be designed to selectively release or close an opening of the fluid guide between the lifting tube port and the suction port. The shut-off flap can then be mechanically coupled to the first or the second operating element in such a way that an opening angle of the shut-off flap is adjustable by actuating the first operating element or the second operating element, in particular the shut-off flap is adjustable between the blocking position and the release position.

In order to facilitate a release of an object suctioned by a suction gripping device, it can also be advantageous if the shut-off valve also comprises a shut-off valve ventilation port for ventilating the suction port, in particular for ventilating the fluid guide between the lifting tube port and the suction port.

The shut-off valve can then have a closing member which is designed to selectively release or block the shut-off valve ventilation port. The closing member has in particular a closed position in which the shut-off valve ventilation port is closed, and a ventilation position in which the shut-off valve ventilation port is open.

Advantageously, the closing member can be coupled, in particular mechanically forcibly coupled, to the shut-off member in such a way that, when the shut-off member is in the blocking position, the closing member is in particular in the ventilation position, in particular a fluidic connection is produced between the surroundings of the operating device and the suction port. Furthermore, it can be advantageous that, when the shut-off member is in the release position, the closing member is in the closed position, in particular a fluidic connection between the surroundings and the suction port is interrupted.

The shut-off valve ventilation port can be open to the surroundings of the operating device, so that ambient air can flow into the suction port, in particular into the fluid guide between the lifting tube port and the suction port. It is also conceivable for the shut-off valve ventilation port to be connected to a pressure fluid supply, in particular a compressed air supply. In this way, a rapid set-down or release of an object held by a suction gripping device can be facilitated.

The closing member can advantageously be designed as a ventilation flap. It can then be advantageous if the shut-off flap and the ventilation flap are held on the operating device so as to be pivotable about a common pivot axis, which makes it possible to adjust the two flaps in a simple and reliable manner.

In the context of a particularly advantageous embodiment, the valve flap, the shut-off member and the closing member can be mechanically coupled to one another in such a way that
in a first operating configuration of the operating elements, the valve flap of the ventilation valve is in the closed position, the shut-off member is in the release position and the closing member is in the closed position,
in a second operating configuration of the operating elements, the valve flap of the ventilation valve is at least partially open, the shut-off member is in the release position and the closing member is in the closed position, and
in a third operating configuration of the operating elements, the valve flap is open (in particular open further than in the second operating configuration, preferably is in the open position), the shut-off member is in the blocking position, and the closing member is in the ventilation position.

In the first operating configuration, the first operating element is preferably in the actuating position and the second operating element in the non-actuating position. In the second operating configuration, the first and the second operating elements are preferably each in an intermediate position between their respective actuating positions and their respective non-actuating positions, further preferably in their respective neutral positions. In the third operating configuration, the first operating element is preferably in the non-actuating position and the second operating element in the actuating position.

The three operating configurations can in particular be run through one after the other when actuating, in particular pressing, the second operating element. In order to give an operator haptic feedback as to when the third operating configuration is reached (in which the suction gripping device is ventilated and thus a suctioned object is detached), it can be advantageous if the second operating element is acted upon, in particular spring-loaded, counter to the actuating direction in such a way that, for transferring the second operating element from the second operating configuration into the third operating configuration, in particular for transferring into the actuating position, the loading must be overcome. The loading is noticeable as a pressure point, which gives the operator haptic feedback.

The object described above is also achieved by a tube lifter having an operating device described above. The features and advantages of the operating device described above in conjunction with the operating device can also serve to design the tube lifter, so that reference is made to the above disclosure in order to avoid repetition.

The tube lifter comprises in particular a lifting tube which has a tube interior and can be shortened by applying a vacuum to the tube interior and can be extended again by ventilating the tube interior. The tube lifter additionally comprises an end effector, in particular in the form of a suction gripping device, for gripping an object. The end effector can in particular be supplied with a vacuum through the tube interior of the lifting tube. As mentioned above, the operating device is preferably arranged between the lifting tube and the end effector, the lifting tube being fluidically connected to the lifting tube port and the end effector being connected to the end effector coupling.

The invention is explained in more detail below with reference to the figures. In the drawings:

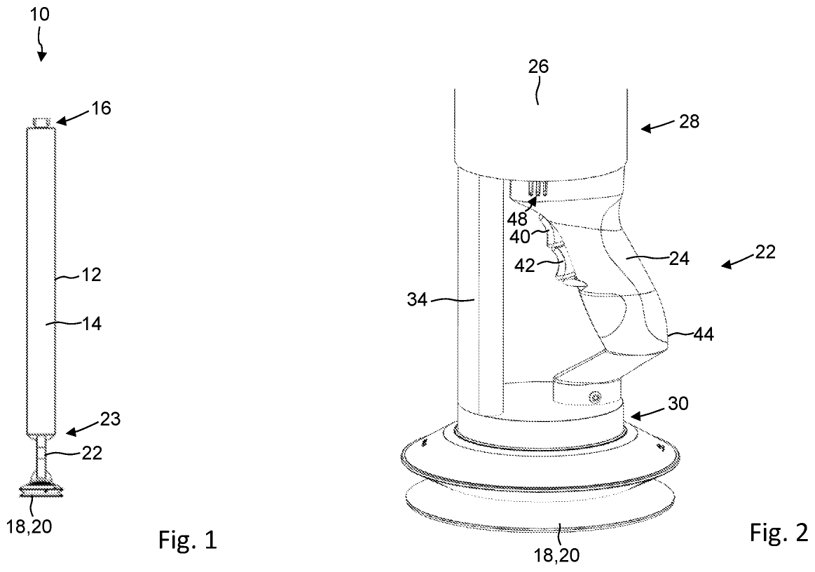

FIG. 1 shows a sketched representation of an embodiment of a tube lifter;

FIG. 2 shows an enlarged detail of the tube lifter according to FIG. 1 in the region of the operating device;

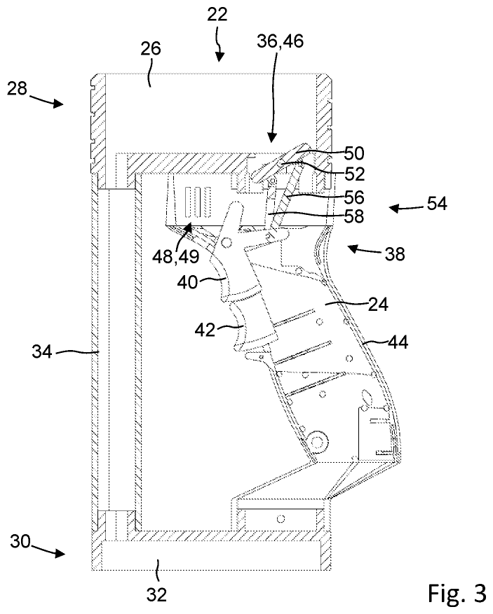

FIG. 3 shows a sketched representation of the operating device according to FIG. 2, in a side view;

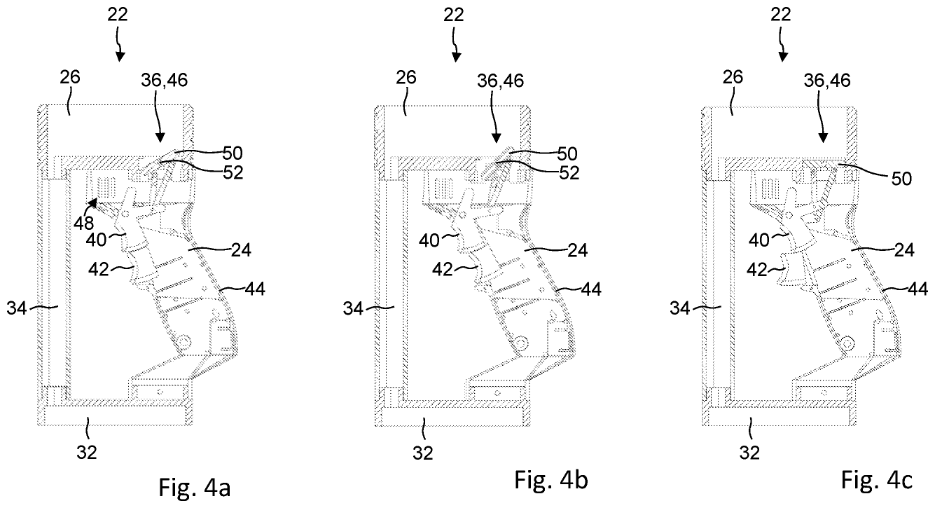

FIG. 4a-c show sketched representations of the operating device according to FIG. 3 for explaining different actuating positions of the operating elements; and

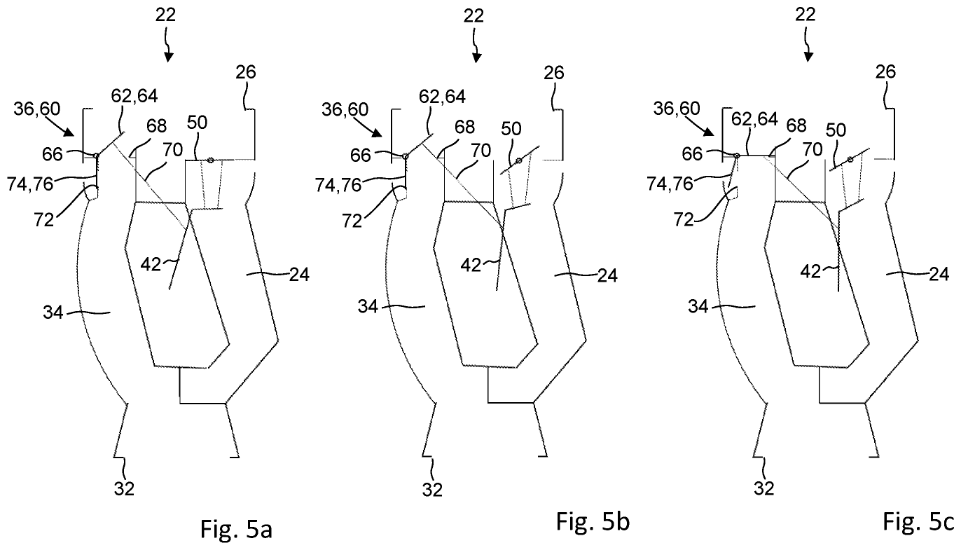

FIG. 5a-c show simplified schematic representations of a further embodiment of the operating device with shut-off valve.

In the following description and in the figures, identical reference signs are in each case used for identical or corresponding features.

FIG. 1 shows an embodiment of a tube lifter, which is denoted as a whole by reference sign 10. The tube lifter 10 comprises a lifting tube 12, which encloses a tube interior 14. The lifting tube 12 can be shortened by applying a vacuum to the tube interior 14 and can be extended again by ventilating the tube interior 14. In other words, depending on the pressure level in the tube interior 14, the lifting tube 12 is reversibly shortened or lengthened, for example under the effect of the weight force.

The lifting tube 12 can be connected at a first (upper) end 16 to a support or frame. It is also conceivable for the lifting tube 12 to be fastened at the upper end 16 to a manipulator, for example in the form of a column pivoting crane, and thus to be displaceable by the manipulator.

The tube lifter 10 also comprises an end effector 18 for gripping an object (not shown). In the example shown, the end effector 18 is preferably designed as a suction gripping device 20 for suctioning an object. As explained in detail below, the end effector 18 (suction gripping device 20) can preferably be supplied with a vacuum through the tube interior 14 of the lifting tube 12. By shortening the lifting tube 12, the suction gripping device 20 and thus an object suctioned by the suction gripping device 20 can be lifted.

In order to operate the tube lifter 10, an operating device 22 is provided (detailed view cf. FIGS. 2 and 3). The operating device 22 is arranged between the lifting tube 12 and the end effector 18. The operating device 22 is preferably held at the second (lower) end 23 of the lifting tube 12.

An embodiment of the operating device 22 is explained in greater detail below with reference to FIGS. 2 and 3.

The operating device 22 comprises an operating handle 24 (handle), which is designed in particular in such a way that an operator can grip it using one hand. In this respect, the operating device 22 is in particular a single-hand operating device.

The operating device 22 additionally comprises a lifting tube port 26 for fluidic connection to the tube interior 14 of the lifting tube 12 (cf. FIG. 3). The lifting tube port 26 can in particular be part of a lifting tube coupling 28, which also comprises a connection device for mechanically connecting the operating device 22 to the lifting tube.

On a side opposite the lifting tube port 26, the operating device 22 has an end effector coupling 30 for coupling the end effector 18 (cf. FIG. 3). In the example, the end effector coupling 30 also comprises an optional suction port 32 for fluidic connection to the end effector 18. As explained in detail below, the suction port 32 is fluidically connected to the lifting tube port 26 by means of an optional tubular fluid guide 34 and can thus be supplied with a vacuum through the lifting tube 12.

The operating device 22 additionally comprises a valve device 36 for controlling fluidic connections (also explained in detail below). The valve device 36 is arranged in particular within a housing 44 of the operating device 22 (cf. FIG. 2). In order to actuate the valve device 36, an operating mechanism 38 is provided which comprises a first operating element 40 and a second operating element 42, the function of which is also explained in greater detail below.

As can be seen in FIG. 2, the first operating element 40 and the second operating element 42 are arranged separately from one another on the operating handle 24 and are pivotably mounted thereon (in the manner of a pistol trigger). The operating handle 24 is preferably shaped in such a way that an operator can grip it using one hand and in this case can actuate the operating elements 40, 42 with this hand (e.g., the first operating element 40 with the index finger and the second operating element 42 with the middle finger).

As explained in detail below, the operating elements 40, 42 are pivotable between respective actuating positions and respective non-actuating positions. For example, FIG. 4c shows an operating configuration in which the first operating element 40 is in the actuating position and the second operating element 42 is in the non-actuating position. By contrast, FIG. 4b shows an exemplary operating configuration in which the second operating element 42 is in the actuating position and the first operating element 40 is in the non-actuating position. Between these two end positions (actuating position and non-actuating position), the operating elements 40, 42 each pass through a neutral position (cf. FIG. 4a).

In embodiments (not shown), the first operating element 40 and the second operating element 42 can also be arranged on the operating handle 24 so as to be translationally displaceable, in particular are guided linearly. In this respect, the operating elements 40, 42 can be linearly displaceable between respective actuating positions and respective non-actuating positions.

As explained in detail below, the first operating element 40 and the second operating element 42 are mechanically forcibly coupled in such a way that, when the first operating element 40 is transferred in the direction of the actuating position (i.e., when the first operating element is actuated), the second operating element 42 is automatically transferred in the direction of the non-actuating position, and vice versa.

As can be seen in FIG. 3, the operating handle 24 is, by way of example and preferably, designed as a hollow body with a housing 44. The operating elements 40, 42 are then preferably held on the operating handle 24 in such a way that they can be pressed into the housing 44 (starting from a non-actuating position in the direction of the actuating position).

The valve device 36 comprises a ventilation valve 46 for ventilating the lifting tube connection 26 and thus for ventilating the tube interior 14 of the lifting tube 12. Specifically, a flow path from the lifting tube port 26 to the surroundings can be selectively released or blocked by means of the ventilation valve 46. In the example shown, the ventilation valve 46 is designed to, if necessary, release or block a fluidic connection between the lifting tube port 26 and a lifting tube ventilation port 48. By way of example, the lifting tube ventilation port 48 is formed by corresponding apertures or openings 49 in the region of the operating handle 24 (in particular in the housing 44 of the operating handle 24) (cf. FIG. 3).

The ventilation valve 46 comprises a valve flap 50 which can assume an open position (cf. FIG. 4b) and a closed position (cf. FIG. 4c). In the open position, a flow path from the lifting tube port 26 to the lifting tube ventilation port 48 and thus to an environment of the operating device 22 is released. In the closed position, this flow path is closed. The valve flap 50 is adjustable, in particular continuously, between these two extreme positions (open position and closed position).

As can be seen from FIG. 3, the valve flap 50 is mounted on the operating device 22 so as to be pivotable about a pivot axis 52. In the example shown, the pivot axis 52 runs in the valve flap plane. In embodiments (not shown), however, the pivot axis 52 can also be spaced apart from the valve flap plane.

By way of example and preferably, the pivot axis 52 is arranged centrally. In particular, the valve flap 50 is designed in the form of a circular disk and the pivot axis 52 runs through a circle center.

The first and the second operating elements 40, 42 are mechanically coupled to the valve flap 50 via a transmission device 54 in such a way that the valve flap 50 can be pivoted about the pivot axis 52 by actuating the first operating element 40 or the second operating element 42 and thus an opening angle of the valve flap 50 can be adjusted.

In the specific example, the first operating element 40 is connected to the valve flap 50 via a first connecting element 58 (for example in the form of a first connecting rod), and the second operating element 42 is connected to the valve flap 50 via a second connecting element 56 (for example in the form of a second connecting rod). The first operating element 40 and the second operating element 42 are in this respect forcibly coupled to one another via the valve flap 50.

The first connecting element 58 is pivotably mounted both on the first operating element 40 and on the valve flap 50, and the second connecting element 56 is mounted pivotably both on the second operating element 42 and on the valve flap 50.

As can be seen from FIG. 3, the connecting elements 56, 58 engage with portions of the valve flap 50 opposite one another in relation to the pivot axis 52. In this way, a forced coupling of the first and second operating elements 40, 42 is realized in such a way that, when an operating element 40, 42 is transferred in the direction of its actuating position (i.e., when this operating element 40, 42 is pressed into the housing 44), the other operating element 40, 42 is transferred in the direction of the non-actuating position (and is thus pressed out of the housing 44).

As mentioned above, the operating mechanism 38, in particular the first operating element 40, the second operating element 42 and/or the transmission device 54, and/or the valve flap 50, are mounted in a dragging fashion in such a way that the valve flap 50 remains in a set configuration even when the operating device 22 is released, and thus the lifting tube remains in a preset length (suspended position).

The exact functioning of the operating mechanism 38 and the ventilation valve 46 is explained in more detail below on the basis of exemplary operating configurations with reference to FIGS. 4a to 4c.

FIG. 4a shows an exemplary operating configuration of the operating device 22 in which both the first operating element 40 and the second operating element 42 are in the neutral position. In this neutral position, the valve flap 50 is at least partially open, so that ambient air can flow into the tube interior 14 of the lifting tube 12. By way of example and preferably, in the neutral position an inflow of ambient air can be set such that the lifting tube 12 is held in a defined starting suspension position (between a maximum pulled-out and a maximum retracted position).

If, starting from this operating configuration, the second operating element 42, for example, is now actuated (i.e., the second operating element 42 is pressed toward its actuating position), the valve flap 50 is further opened and thus ambient air is increasingly flowing into the tube interior 14 of the lifting tube 12, so that the latter extends (cf. FIG. 4b). As a result of the forced coupling described above between the first and the second operating element 40, 42, the first operating element 40 is automatically transferred into the non-actuating position (i.e. pushed out of the housing 44, cf. FIG. 4b).

In order to shorten the lifting tube 12 again, the operator can actuate (i.e., press into the housing 44) the first operating element 40 starting from the operating configuration according to FIG. 4b, whereby the valve flap 50 is transferred into the closed position (cf. FIG. 4c). Since ambient air, or only a small amount of ambient air, flows into the tube interior 14, the vacuum in the lifting tube 12 increases so that the latter contracts. As can be seen in a comparison of FIGS. 4b and 4c, when the first operating element 40 is actuated, the second operating element 42 is transferred into the non-actuating position (i.e. pushed out of the housing 44) as a result of the forced coupling via the valve flap 50.

The suction gripping device 20 can in principle be supplied with a vacuum via a separate vacuum supply. However, the suction gripping device 20 is preferably supplied with a vacuum via the optional fluid guide 34 and the suction port 32. In this context, it is possible for a control valve (not shown) to be provided on the suction gripping device 20 itself, via which control valve a vacuum supply provided via the suction port 32 can be selectively released (for suctioning and thus gripping an object) or can be blocked (for setting down the object).

FIGS. 5a to 5c show a simplified schematic representation of a further embodiment in which such a control of the vacuum supply to the suction gripping device 20 is realized in the operating device 22. The operating device 20 according to FIG. 5a to 5c is substantially identical to the operating device 22 according to FIG. 3, with the exception that a shut-off valve 60 is additionally provided. For reasons of clarity, a repeated description of the various features of the operating device 22 is therefore spared. In addition, only those components of the operating device 22 which are required for understanding the technical features and advantages described below are shown in FIGS. 5a to 5c.

As shown in FIG. 5a, the valve device 36 comprises a shut-off valve 60 for shutting off or releasing a flow path between the lifting tube port 26 and the suction port 32. The shut-off valve 60 comprises a shut-off member 62 which can assume a release position (cf. FIG. 5a) and a blocking position (cf. FIG. 5c). In the example shown, the shut-off member 62 is designed as a shut-off flap 64 which is held on the operating device 22 pivotably about a pivot axis 66. The shut-off flap 64 is designed to selectively close (locking position, cf. FIG. 5c) or release (release position, cf. FIG. 5a) an opening 68 of the fluid guide 34.

The shut-off flap 64 is mechanically coupled to the second operating element 42 via a transmission device 70 (only schematically indicated in FIG. 5a to 5c) in such a way that an opening angle of the shut-off flap 64 can be adjusted and thus the shut-off valve 60 can be actuated by actuating the second operating element 42 (the first operating element 40 is not shown in FIGS. 4a to 4c for reasons of clarity). In embodiments which are not shown, it is also possible for the shut-off flap 64 to be mechanically coupled to the first operating element 40 or to the first and the second operating element 42 accordingly.

In the example shown, the shut-off valve 60 also comprises an optional shut-off valve ventilation port 72 (only schematically shown in FIG. 5a to 5c) for ventilating the suction port 32. As can be seen from FIG. 5a, the shut-off valve ventilation port 72 is designed to connect the fluid guide 34 to the surroundings.

The shut-off valve 60 also comprises a closing member 74, by way of example and preferably in the form of a ventilation flap 76, which can assume a closed position (shut-off valve ventilation port 72, cf. FIG. 5a) and a ventilation position (shut-off valve ventilation port 72, cf. FIG. 5c).

As explained in detail below, the closing member 74 (ventilation flap 76) is mechanically forcibly coupled to the shut-off member 62 (shut-off flap 64) in such a way that when the closing flap 64 is in the blocking position, the ventilation flap 76 is in a ventilation position in which the shut-off valve ventilation port 72 is released (cf. FIG. 5c) and then, when the shut-off flap 64 is in the release position, the ventilation flap 76 is in a closed position in which the shut-off valve ventilation port 72 is shut off and thus a fluidic connection between the surroundings and the suction port 32 is interrupted. For this purpose, the shut-off flap 64 and the ventilation flap 76 are pivotably connected to one another about a common pivot axis 66 in the example shown.

The cooperation of the ventilation valve 46 and the shut-off valve 60 is explained in greater detail below on the basis of exemplary operating configurations with reference to FIGS. 5a to 5c.

FIG. 5a shows a first operating configuration in which the second operating element 42 is in the non-actuating position and the first operating element 40 (not shown) is thus in the actuating position. As can be seen from FIG. 5a, in this operating configuration, the valve flap 50 is located in the closed position, the shut-off flap 64 in the release position and the ventilation flap in the closed position. In this operating configuration, the suction port 32 and thus an end effector 18 arranged thereon are supplied with a vacuum via the fluid guide, so that an object can be suctioned. Due to the fact that the valve flap 50 is in the closed position and thus no or only slightly ambient air flows into the tube interior 14, the vacuum in the tube interior 14 increases, so that the lifting tube 12 is shortened. The first operating configuration is suitable in this sense for lifting an object.

FIG. 5b shows a second operating configuration in which the second operating element 42 is located in an intermediate position between the non-actuating position and the actuating position, for example in the above-mentioned neutral position, and the first operating element 40 is thus also located in an intermediate position, for example the neutral position. As can be seen from FIG. 5b, in this operating configuration, the valve flap 50 is located in an at least partially open position, the shut-off flap 64 in the release position and the ventilation flap 76 in the closed position. In this operating configuration, the suction port 32 and thus an end effector 18 arranged thereon are supplied with a vacuum via the fluid guide, so that an object can be suctioned. Since the valve flap 50 is open, ambient air flows into the tube interior 14, so that a pressure in the tube interior is increased in comparison with the configuration according to FIG. 5a and the lifting tube 12 is extended as a result. The second operating configuration is in this sense an operating configuration for lowering the tube lifter 10.

FIG. 5c shows a third operating configuration in which the second operating element 42 is in the actuating position and the first operating element 40 is thus in the non-actuating position. As can be seen from FIG. 5c, in this operating configuration, the valve flap 50 is located in the open position, the shut-off flap 64 in the closed position and the ventilation flap 76 in the ventilation position. In this operating configuration, the suction port 32 and thus an end effector 18 arranged thereon are in this sense ventilated via the shut-off valve ventilation port 72, so that a suctioned object can be set down. The third operating configuration is in this sense an operating configuration for setting down an object.

1. An operating device for a tube lifter that comprises an end effector and a lifting tube having a tube interior, the lifting tube being able to be shortened by applying a vacuum to the tube interior and being able to be extended again by ventilating the tube interior, the operating device comprising:
a lifting tube port for fluidic connection to the tube interior of the lifting tube;
an end effector coupling for coupling the end effector to the operating device;
a valve device for controlling fluidic connections; and
an operating mechanism for actuating the valve device, wherein
the valve device comprising a ventilation valve for ventilating the lifting tube port, and
the ventilation valve has a valve flap, which is adjustable between an open position and a closed position, in the open position a flow path from the lifting tube port to the surroundings being released and in the closed position this flow path being closed, the operating mechanism comprising a first operating element and a second operating element, the first and the second operating element being mechanically coupled to the valve flap in such a way that by actuating the first and/or the second operating element an opening angle of the valve flap is adjustable.

2. The operating device according to claim 1, wherein the first and the second operating element are mechanically coupled to the valve flap in such a way that, by actuating the first operating element, the valve flap can be transferred into the closed position and by actuating the second operating element the valve flap can be transferred into the open position.

3. The operating device according to claim 1, wherein the first and the second operating element are arranged on the operating device manually adjustably, translationally displaceably, wherein the first and the second operating elements are mechanically coupled to the valve flap via a transmission device in such a way that an adjusting movement of the first operating element and/or an adjusting movement of the second operating element is transferred into an opening or closing movement of the valve flap.

4. The operating device according to claim 1, wherein the first operating element, the second operating element and/or the transmission device, and/or the valve flap are designed to be self-locking, dragging, in such a way that the valve flap remains in a set configuration.

5. The operating device according to claim 1, wherein the valve flap is held on the operating device so as to be pivotable about a pivot axis, preferably arranged centrally in relation to the valve flap.

6. The operating device according to claim 5, wherein the first operating element is coupled to the valve flap via a first connecting element, wherein the second operating element is coupled to the valve flap via a second connecting element, wherein the first and the second connecting element engage on the valve flap at portions of the valve flap opposite the pivot axis.

7. The operating device according to claim 1, wherein the first and the second operating elements an assume, alternately, an actuating position and a non-actuating position, wherein the valve flap is in the closed position in the actuating position of the first operating element, and wherein the valve flap is in the open position, in the actuating position of the second operating element.

8. The operating device according to the claim 7, wherein the first and the second operating element, via the valve flap, are mechanically forcibly coupled in such a way that, when the first operating element is transferred in the direction of the actuating position, the second operating element is automatically transferred in the direction of the non-actuating position, and vice versa.

9. The operating device according to claim 7, wherein the first and the second operating element between their respective non-actuating positions and their respective actuating positions pass through respective neutral positions, wherein the first operating element is likewise in the neutral position when the second operating element is in the neutral position, in particular wherein the valve flap is open in the neutral position of the first and the second operating element.

10. The operating device according to claim 9, wherein the operating device has a housing, wherein the first and the second operating element are held on the housing translationally, in such a way that the operating elements are pushed into the housing at least in portions in their respective actuating positions relative to the neutral position and in their non-actuating position protrude from the housing relative to the neutral position at least in portions.

11. The operating device according to claim 1, wherein the operating device comprises an operating handle that can be grasped by one hand, wherein the first and the second operating element are arranged on the operating handle, in such a way that the first operating element can be actuated with a first finger of a hand, the index finger, and in such a way that the second operating element can be actuated with a second finger of the hand, the middle finger.

12. The operating device according to claim 1, wherein the end effector coupling comprises a suction port for fluidic connection to the end effector, being a suction gripping device, wherein the lifting tube port and the suction port are fluidically connected to one another via a fluid guide.

13. The operating device according to claim 12, wherein the valve device additionally has a shut-off valve for blocking or releasing a flow path between the lifting tube port and the suction port, wherein the shut-off valve has a shut-off member which can assume a release position and a blocking position, wherein in the release position the flow path between the lifting tube port and the suction port is released and in the blocking position the flow path between the lifting tube port and the suction port is blocked.

14. The operating device according to claim 13, wherein the shut-off member of the shut-off valve and the valve flap of the ventilation valve are mechanically coupled to one another via the first and/or the second operating element in such a way that the shut-off member is in the release position when the valve flap is in the closed position.

15. The operating device according to claim 13, wherein the shut-off member is designed as a shut-off flap, wherein the shut-off flap is mechanically coupled to the first or the second operating element in such a way that an opening angle of the shut-off flap is adjustable by actuating the first or second operating element, the shut-off flap is adjustable between the blocking position and the release position.

16. The operating device according to claim 15, the shut-off valve additionally comprising:
a shut-off valve ventilation port for ventilating the fluid guide between the lifting tube port and the suction port, and
a closing member for blocking or releasing the shut-off valve ventilation port, wherein the closing member can assume a closed position and a ventilation position, wherein the shut-off valve ventilation port is shut off in the closed position and is released in the ventilation position.

17. The operating device according to claim 16, wherein the closing member is mechanically forcibly coupled, to the shut-off member in such a way that, when the shut-off member is in the blocking position, the closing member in the ventilation position and, when the shut-off member is in the release position, the closing member is in the closed position.

18. The operating device according to claim 16, wherein the closing member is designed as a ventilation flap, wherein the shut-off flap and the ventilation flap are held on the operating device so as to be pivotable about a common pivot axis.

19. The operating device according to claim 16, wherein the valve flap, the shut-off member and the closing member are mechanically coupled to one another via the operating mechanism in such a way that
in a first operating configuration, in which the first operating element is in the actuating position and the second operating element in the non-actuating position, the valve flap is in the closed position, the shut-off member is in the release position, and the closing member is in the closed position;
in a second operating configuration, in which the first and the second operating element are each in an intermediate position between their actuating position and their non-actuating position, in their respective neutral positions, the valve flap is at least partially open, the shut-off member is in the release position, and the closing member is in the closed position, and
in a third operating configuration, in which the first operating element is in the non-actuating position and the second operating element is in the actuating position, the valve flap is in the open position, the shut-off member is in the blocking position, and the closing member is in the ventilation position.

20. A tube lifter comprising said operating device.
